(19) United States
(12) Patent Application Publication
(10) Pub. No.: US 2017/0365016 A1
(43) Pub. Date: Dec. 21, 2017

(54) 1-Click Cancellation And Refund of Assets

(71) Applicant: Roomer Travel LTD., Tel Aviv (IL)

(72) Inventor: Gon Ben David, Givat Ela (IL)

(21) Appl. No.: 15/542,660

(22) PCT Filed: Nov. 16, 2015
(86) PCT No.: PCT/IB2015/058843

§ 371 Date: Jul. 11, 2017

Related U.S. Application Data
(60) Provisional application No. 62/107,412, filed on Jan. 25, 2015.

(51) Int. Cl. G06Q 50/12; G06Q 30/00; G06Q 20/40; G06Q 30/06; G06Q 10/02

(52) U.S. Cl. CPC G06Q 50/12; G06Q 30/0645; G06Q 10/02; G06Q 20/407; G06Q 30/012

(57) ABSTRACT

A method of refunding and reselling by a refund service items bought online at an agent's website, comprising: receiving a protection request from an agent's website for user purchasing an item on an agent's website; providing the requested protection for a protection price; receiving a refund request from the agent's website for a user having purchased a protected item; paying as refund part of the price paid by the user to the agent for the item; and returning the item to a central repository for resale.

### FIELD OF THE INVENTION

The present invention is in the field of purchasing and more specifically in providing refund option for a purchase.

### BACKGROUND

Hotel room reservations are mostly done nowadays on agents' websites, which may offer other complementary products such as flight tickets, relevant touristic sites and events tickets etc.

The rooms offered may be divided into two relevant categories: refundable rooms and non-refundable rooms, where obviously the refundable rooms are more expensive due to a refund option premium.

FIG. 1A is a schematic block diagram showing prior art hotel rooms reservation system 100, comprising a plurality of agent sites 110 (only one shown) which are connected with various databases 150-152 from which they receive specifications of both refundable 130 and non-refundable 140 rooms available. When a user 170 who has reserved a refundable room wishes to cancel the reservation, the agent who sells rooms for a plurality of hotels can only return the refunded reservation to the original database 160 from which the room had been initially received.

FIG. 1B shows the two price levels according to the prior art mechanism, namely a lower price for non-refundable rooms and a higher price for refundable rooms.

### SUMMARY

According to an aspect of the present invention there is provided a method of receiving 1-click refund for items bought online at an agent's website, comprising: purchasing an item online from an items repository offered by the agent; purchasing from a refund service a protection options for a protection price; and canceling the purchase of the item and receiving as refund part of the price paid for the item from the refund service.

According to another aspect of the present invention there is provided a method of enabling 1-click refund and resale of items bought online at an agent's website, comprising: selling an item online from an items repository offered by the agent; offering by a refund service, for a protection price added to the sold item's price, a protection option; receiving a refund request for the item bought with the protection option; paying as refund part of the price paid for the item; and returning the item to a central repository for resale.

According to yet another aspect of the present invention there is provided a method of 1-click refunding and reselling by a refund service items bought online at an agent's website, comprising: receiving a protection request from an agent for a user purchasing an item; providing the requested protection for a protection price; receiving a refund request from the agent; paying as refund part of the price paid by the user for the item; and returning the item to a central repository for resale.

The agent and the refund service may be the same.

The protection and refund options may be implemented as an API of the refund service embedded in the agent's website.

The protection price may be fixed.

The protection price may be a fixed percentage of the item's price.

The protection price may be determined based on the probability to resell the item.

The item may be a hotel room.

According to yet another aspect of the present invention there is provided a system for 1-click refunding and reselling by a refund service items bought online at agents' websites, comprising: a service website comprising a protection engine, a refund engine and an items repository; and a service API embedded in a plurality of agents' websites, said service API configured to communicate between said agents' websites and said service website to enable refund and resale related operations.

The protection engine may be configured to receive a protection request from the service API for an item purchased on an agent's website, determine a protection price and store the transaction details.

The refund engine may be configured to receive a refund request from the service API for an item purchased on an agent's website with protection, calculate a refund amount and refund the calculated amount.

The service website may be further configured to operate as an agent's website.

The service website may further comprise a marketplace service configured to enable second hand trading of items.

The items for sale in the marketplace may comprise part of the service's items repository.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1A is a schematic block diagram showing prior art hotel rooms reservation system;

FIG. 1B shows the two price levels according to the prior art mechanism;

FIG. 2A is a schematic block diagram showing the hotel rooms reservation system according to the present invention;

FIG. 2B shows the three price levels according to the mechanism of the present invention;

FIG. 3 is a schematic block diagram of the Roomer system components;

FIG. 4 is a flowchart showing the operation of the Protection engine; and

FIG. 5 is a flowchart showing the operation of the Refund engine.

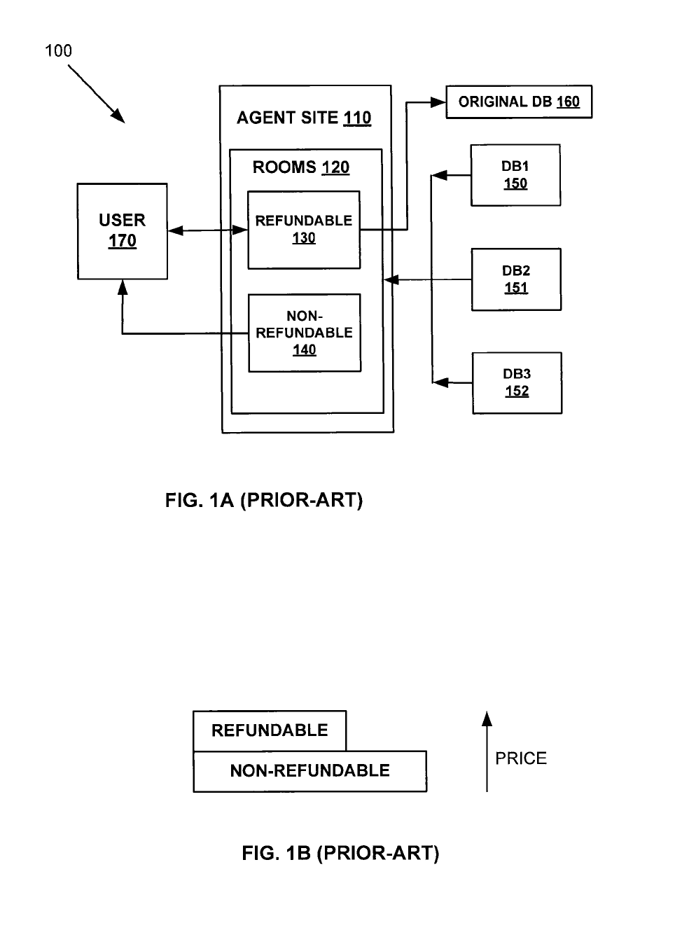

### DETAILED DESCRIPTION OF THE INVENTION

The present invention provides “Roomer”—a system and method that acts as a partner to room selling agents and provides their clients a 1-click option of cancelling a non-refundable reservation previously made through the same agent for a fee.

An agent in the travel industry may be, for example: hotel, hotel chain, OTA (online travel agent), meta search organization, whole sale (GDS—global distribution system), other hotel rooms and/or short term apartments (like in Air B&B) sellers.

Same goes for other vertical services sellers (e.g. flight tickets, event tickets).

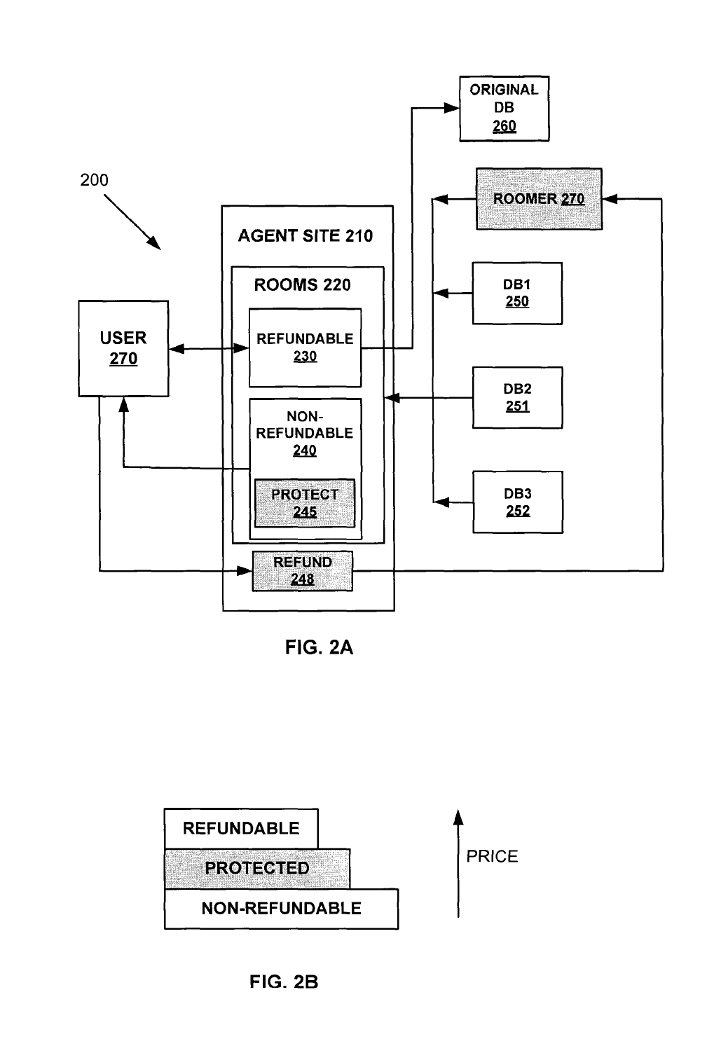

FIG. 2A is a schematic block diagram showing the hotel rooms reservation system 200 according to the present invention.

The system comprises, similar to the system 100, a plurality of agent sites 210 (only one shown) which are connected with various databases 250-252 from which they receive specifications of both refundable 230 and non-refundable 240 rooms available.

The hotel reservations user interface offers a “Protect” option 245 to customers making non-refundable reservations. Alternatively, protection may be requested by email, SMS, phone call, visit, etc.

The user interface may also include a “Refund” option 248 to be used for requesting refund. Alternatively, refund may be requested by email, SMS, phone call, visit, etc.

System 200 includes an additional connection to Roomer's database 270 of available hotel rooms. Rooms refunded by Roomer are returned to the Roomer database 270 and are now available for resale.

FIG. 2B shows the three price levels according to the mechanism of the present invention, namely a lower price for non-refundable rooms, a middle price for non-refundable rooms with Roomer protection and a higher price for refundable rooms.

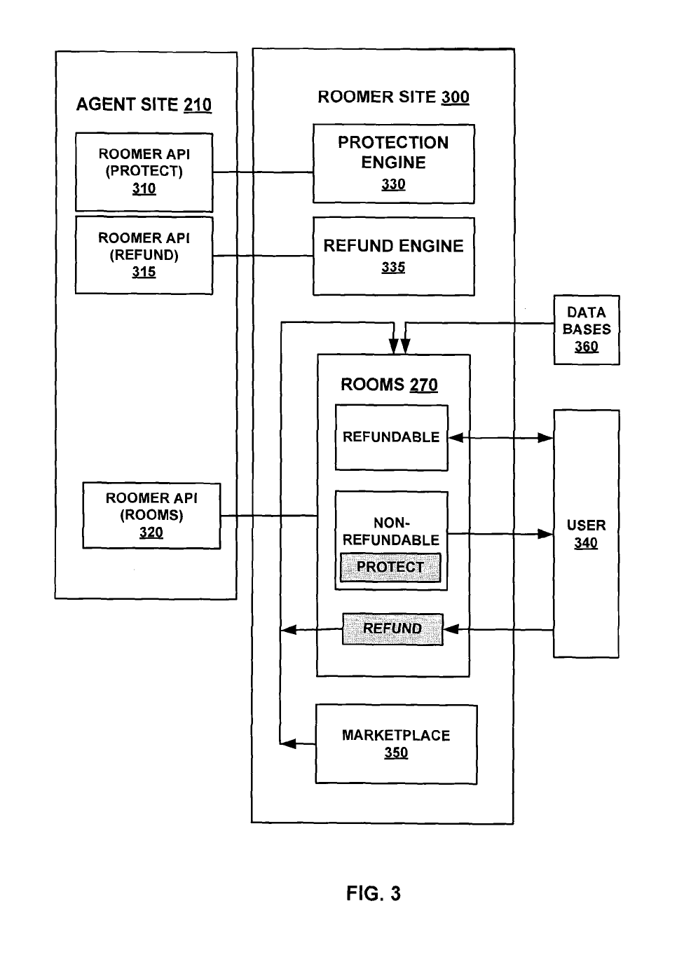

FIG. 3 is a schematic block diagram of the Roomer system components, comprising a Roomer website 300 and a Roomer Application Interface (API) embedded in the agents' (partners') websites for enabling the “Protect” option 310 and the “Refund” option 315 and for accessing Roomer's data base of available rooms 320.

The Roomer website 300 includes a Protection engine 330, a Refund engine 335 and a rooms repository 270.

The Roomer website 300 functions in four different roles:
1.As a refund partner to agents selling hotel rooms;
2.As an agent selling hotel rooms to users;
3.As a data base for hotel rooms available to agents;
4.As a marketplace 350, such as for example https://www.roomertravel.com, which serves as a trading arena for unused rooms or other touristic services.

The Roomer's rooms repository 270 receives available rooms, like any other agent, from a plurality of databases 360 and from rooms offered on the marketplace 350.

The rooms in the repository 270 are accessible both by agent sites 210, in Roomer's capacity as an available rooms database and by users 340, in its capacity as an agent site.

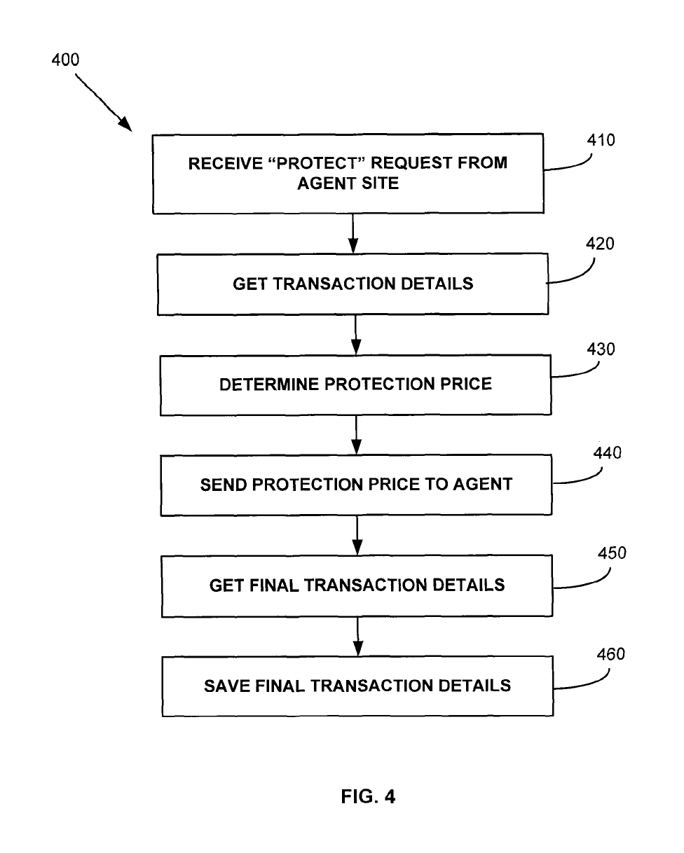

FIG. 4 is a flowchart 400 showing the operation of the Protection engine 330.

In step 410 the Protection engine receives a protect request from an agent's site, indicating that a user has requested to add protection to a non-refundable deal.

In step 420 the Protection engine gets from the agent's site, via the Roomer API, the details of the transaction, including hotel details, room details, user ID and price.

In step 430 the protection price is determined according to any scheme determined by Roomer and accepted by the agent. For example, the protection price may be a fixed sum or a fixed percent of the selling price or a variable percent of the selling price, determined for example according to the probability of reselling the room if returned to the pool, or according to any other pricing scheme.

In step 440 the determined protection price is sent to the agent's site to be displayed to the user.

In step 450 the final transaction details are sent to Roomer from the agent's site and saved in step 460 in the Roomer database.

FIG. 5 is a flowchart 500 showing the operation of the Refund engine 335.

In step 510 the Refund engine receives a refund request from an agent's site, indicating that a user has requested to return a room previously reserved. Alternatively, refund may be requested by email, SMS, phone call, visit, etc.

In step 530 the refund amount is determined according to the stipulation in the protection agreement, e.g. 75% of the original sales price.

In step 540 the determined refund price is sent to the agent's site to be displayed to the user.

In step 550 the user's or agent's account in Roomer is credited with the refund amount or the refund amount is wire-transferred to the user or the agent.

In step 560 Roomer determines a new price and sales policy for the returned room and the room is returned 570 to the repository, where it becomes accessible again to both agents and users.

While the present invention has been described in conjunction with the example of hotel rooms reservation system, it is contemplated that the same principles may be applied to any tangible or intangible asset sold over the Internet by 3rd party agents and not yet delivered. In other words, the invention may be applied to any item (product or service) to which a right has been purchased, some of which do not have a refundable option to begin with. For example, houses/apartments offered on real estate agents' websites, cars offered on car dealers' websites, tickets to an event, enrollment to a course, etc.

As will be appreciated by one skilled in the art, aspects of the present invention may be embodied as a system, method or computer program product. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider),

1. (canceled)

2. (canceled)

3. (canceled)

4. (canceled)

5. (canceled)

7. (canceled)

8. (canceled)

9. (canceled)

10. A system for refunding and reselling items comprising:
a service website comprising a protection engine, a refund engine and an item repository comprising refundable and non-refundable items for sale;
at least one agents' website connected with at least one items repository, said at least one items repository comprising said service website's item repository, said at least one agent's website comprising items repositories of refunadable and non-refundable items for sale; and
a service API embedded in said at least one agent's website, said service API configured to communicate between said at least one agents' website and said service website to enable protection and refund of non-refundable items bought and paid for on said at least one agent's website;
wherein said protection engine is configured to receive a projection request from said at least one agents' website for a non-refundable item through said API and determine said protection price;
wherein said refund engine is configured to receive a refund request from said at least one agents' website for a protected item through said API, calculate a refund amount and refund the calculated amount;
said service website further configured to store said refunded items in said service website's item repository.

12. (canceled)

13. The system of claim 10, wherein said service website is further configured to operate as an agent's website.

14. The system of claim 10, wherein said service website further comprises a marketplace service configured to enable second hand trading of items.

15. The system of claim 14, wherein items for sale in said marketplace comprise part of the service's items repository.

16. (canceled)

17. (canceled)

18. (canceled)
